(19) United States
(12) Patent Application Publication
(10) Pub. No.: US 2003/0089007 A1
(43) Pub. Date: May 15, 2003

(54) Method and device for magnetic translation and rotation

(76) Inventors: Joszef Bognar, Budapest (HU); Sandor Demjan, Budapest (HU)

Correspondence Address: BEEM PATENT GROUP, 221 N. LASALLE STREET, SUITE 2150, CHICAGO, IL, 60601-1402, US

(21) Appl. No.: 10/312,213

(22) PCT Filed: Jun. 28, 2001
(86) PCT No.: PCT/HU01/00071

(30) Foreign Application Priority Data
Jun. 28, 2000 (HU) P 0002467

(51) Int. Cl. G09F 19/00

(52) U.S. Cl. 40/426

(57) ABSTRACT

A magnetic translation and rotation device for transferring translational force and torque from one side of a space divider element to the other side thereof comprises a magnetic cylinder is disposed on one planar surface of a space divider element, with the direction of magnetization of the magnetic cylinder being generally parallel with a longitudinal axis thereof. The longitudinal axis of the magnetic cylinder is generally perpendicular to the plane of the space divider element. On the other side of the space divider element a first magnetic plate and a second magnetic plate are disposed on a transport means, wherein a direction of magnetization of the magnetic plates is perpendicular to a principal plane of the magnetic plates, and wherein the magnetic plates are mounted with their direction of magnetization pointing in opposite directions. The invention also concerns a method based on the operating principle of the device.

The present application is a U.S. National Stage application under 35 U.S.C. §371 of International Application PCT/HU01/00071, filed Jun. 28, 2001, which claims priority to the Hungarian Application P 0002467, filed Jun. 28, 2000, the disclosures of which are incorporated herein by reference.

### BACKGROUND OF THE INVENTION

1. Field of the Invention

The present invention is directed to a magnetic translation and rotation device, mainly for advertising applications.

Magnetic transmission of force and magnetic torque transfer can be particularly useful when motion from one side of a space divider element to the other side thereof is intended, and this without visible mechanical means. The motive force is transmitted from one side of the space divider element to the other by means of magnetic lines of force, so the two areas can be insulated or sealed off from each other. The apparent lack of a transport means can be especially profitable in advertising.

2. Description of the Related Art

International patent application No. PCT/HU98/00018 describes a device for moving a rolling or translating spatial object along one of the plain surfaces of a space divider element by means of a motive means that is disposed on the other side of the space divider element.

U.S. Pat. No. 4,990,117 discloses a solution for moving an object, particularly a traveling toy vehicle, by means of a magnet situated on the opposite side of the space divider element. Neither of the above solutions provides for the apparent rotation of the object around its own axis during the movement of the object along the surface of the space divider element. In order to produce a movement with such effect, existing solutions propose relatively large and complex constructions that are difficult to hide.

### BRIEF SUMMARY OF THE INVENTION

The magnetic rotation and translation device according to the present invention comprises a space divider element and a magnetic cylinder with its direction of magnetisation parallel with the longitudinal axis thereof, where said magnetic cylinder is disposed on one of the plain surfaces of the space divider element. Opposite the magnetic cylinder on the other side of the space divider element a transport means is disposed, with magnetic plates attached to it, where the direction of magnetisation of the magnetic plates is perpendicular to the their principal planes, and where the magnetic plates are mounted in a configuration so that their polarities are pointing in opposite directions.

The transport means provides for the displacement of the magnetic plates with respect to the space divider element and also supports the magnetic plates. If the magnetic plates are displaced along the surface of the space divider element in the direction of the line connecting the point of application of the frictional force arising between the space divider element and the magnetic cylinder and the point of application of the magnetic forces acting between the magnetic cylinder and the magnetic plates, it is possible to transfer the straight-line motion of the magnetic plates to the magnetic cylinder. If, however, we move the magnetic plates along the surface of the space divider element in a direction different from the direction of the line that connects the point of application of the frictional force arising between the space divider element and the magnetic cylinder and the resultant point of application of the magnetic forces acting between the magnetic cylinder and the magnetic plates, we can produce a rotation with a direction that depends on the direction of the displacement of the magnetic plates. The rotary movement is superimposed on the translation and results in a combination of rotation and straight-line motion. The proportion of rotation to straight-line motion may be controlled by adjusting the angle between the displacement of the magnetic plates and the direction of the line that connects the point of application of the frictional force arising between the space divider element and the magnetic cylinder and the resultant point of application of the magnetic forces acting between the magnetic cylinder and the magnetic plates.

The inventive device transforms straight-line motion into rotation because the magnetic interaction between the magnetic plates and the magnetic cylinder keeps the magnetic cylinder in such a position that the geometric axis thereof does not intersect the point of application of the arising frictional forces. At the same time its axial symmetry enables the magnetic cylinder to rotate about its longitudinal axis, resulting in a rotation with respect to the magnetic plates. If the direction of the displacement of the magnetic plates does not coincide with the line that connects the point of application of the frictional force arising between the space divider element and the magnetic cylinder and the resultant point of application of magnetic forces, then a torque is applied to the magnetic cylinder. This torque will turn the magnetic cylinder about its longitudinal axis into a direction determined by the direction of the displacement of the magnetic plates.

The term magnetic cylinder refers not only to magnets of perfect cylindrical shape but to any magnet with a rotational body (body of revolution) or substantially rotational body, or such an arrangement of multiple magnets.

The movement of the magnetic cylinder is best utilised if it carries an element bearing advertising information, especially if the inventive device is applied in a vertical advertising board design. The effect of an advertising means moving and rotating along a space divider without any visible mechanical transport means has proved to be particularly thrilling. The apparent mystery of the movement is increased when, during its movement, the advertising means uncovers an area which was previously covered: and the observer can easily ascertain that the advertising means does not conceal any opening or any visible transport device on the unbroken plain surface of the space divider, and the surface of the space divider element may be completely closed and monolithic.

According to another advantageous embodiment of the inventive device, a guiding means (e.g. a magnet) is attached to the element carried by the magnetic cylinder, with a guiding counterpart (e.g. an iron part) disposed on the space divider element. The guiding means and its counterpart guide the transported element within the range of attraction of each other. The magnetic plates are preferably disposed between the space divider element and the transport means.

A further object of the invention is another magnetic translation and rotation device that also transfers translational force and torque from one side of a space divider element to the other side thereof. The inventive device comprises a magnetic cylinder disposed on one of the plain surface of a space divider element, where the direction of magnetisation of said magnetic cylinder is parallel with the longitudinal axis thereof, and where the axis of the magnetic cylinder is parallel with the plane of the space divider element. Opposite the magnetic cylinder, on the other side of the space divider element a transport means is disposed, with magnetic plates attached to it. The magnetic plates are magnetised in directions perpendicular to their principal planes and are positioned in a configuration so that their polarities are pointing in opposite directions.

The device described above preferably comprises two pairs of magnetic plates, where the direction of magnetisation of the magnetic plates is perpendicular to their respective principal planes, and the magnetic plates are complemented on the other side of the space divider element by two magnetic cylinders arranged along a common longitudinal axis, with said axis being parallel with the plane of the space divider element.

In one of the preferred embodiments of the device described above an advertising means is attached to the magnetic cylinder. The advertising means preferably has a form with rotational symmetry (body of revolution), with the longitudinal axis of said advertising means being parallel with the longitudinal axis of the magnetic cylinder. The displacement of the transport means causes the advertising means to perform a substantially rolling movement along the surface of the space divider element.

A further object of the invention is to provide a method for transferring translational force and torque from one side of a space divider element to the other side thereof. The method comprises the following steps: magnetic plates are positioned along one of the plain surfaces of a space divider element, where the direction of magnetisation of the magnetic plates is perpendicular to their principal planes and where said magnetic plates are mounted in a configuration so that their polarities are opposite to each other, a magnetic cylinder is disposed opposite the magnetic plates on the other side of the space divider element, with the direction of magnetisation of the magnetic cylinder being parallel with its longitudinal axis. The axis of said magnetic cylinder is either aligned with or set perpendicular to the plane of the space divider element. The magnetic plates are moved so as to cause the magnetic cylinder to substantially roll, or, being rotated by the frictional force, to perform a rotary movement along the surface of the space divider element.

Finally, a further object of the invention is a magnetic translation and rotation device in itself, which, by means of magnets attached to a transport means moving along one of the plane surfaces of a space divider element, transfers translational force and/or torque to the other side of the space divider element. The inventive device comprises magnetic plates mounted on the transport means, where the direction of magnetisation of said magnetic plates is perpendicular to their principal planes, and where the magnetic plates are positioned in a such configuration that their polarities point into opposite directions, and the direction of their magnetisation is substantially perpendicular to the plane of the space divider element.

The device described above preferably comprises magnetic plates of substantially equal size, and the transport means is implemented so as to allow for a motion at least in a directions substantially perpendicular to the direction of the line connecting the magnetic centres of the magnetic plates.

### BRIEF DESCRIPTION OF THE SEVERAL VIEWS OF THE DRAWINGS

Possible implementations and embodiments of the magnetic translation and rotation device herein described are exemplified by the attached drawings, where

FIG. 1 is a perspective view of one embodiment of the device for magnetic translation and rotation.

FIG. 2 is another perspective view of the embodiment of the device for magnetic translation and rotation shown in FIG. 1.

FIG. 3 shows the parts of the embodiment of the device for magnetic translation and rotation shown in FIG. 1 in an exploded view.

FIG. 4 shows the top view of the device for magnetic translation and rotation depicted in FIG. 1.

FIG. 5 shows the front view of the device for magnetic translation and rotation depicted in FIG. 1.

FIG. 6 is a perspective view of another embodiment of the device for magnetic translation and rotation, similarly to that shown in FIG. 1.

FIG. 7 is another perspective view of the embodiment of the device for magnetic translation and rotation shown in FIG. 6, with the cover of the advertising means removed.

FIG. 8 shows the parts of the embodiment of the device for magnetic translation and rotation shown in FIG. 6 in an exploded view.

FIG. 9 shows the sectional view of the device for magnetic translation and rotation depicted in FIG. 6, similarly to that shown in FIG. 1.

FIG. 10 shows a schematic front view of the embodiment depicted in FIG. 6.

FIG. 11 is a schematic side view of the embodiment depicted in FIG. 6.

FIG. 12 shows the top view of yet another embodiment of the device for magnetic translation and rotation.

FIG. 13 showing the front view of the embodiment shown in FIG. 12.

FIG. 14 depicts a sectional view of a further embodiment of the inventive magnetic translation and rotation device similar to that shown in FIG. 9.

FIG. 15 shows the schematic front view of the embodiment shown in FIG. 14.

FIG. 16 shows the schematic side view of the embodiment depicted in FIG. 14.

### DETAILED DESCRIPTION OF THE INVENTION

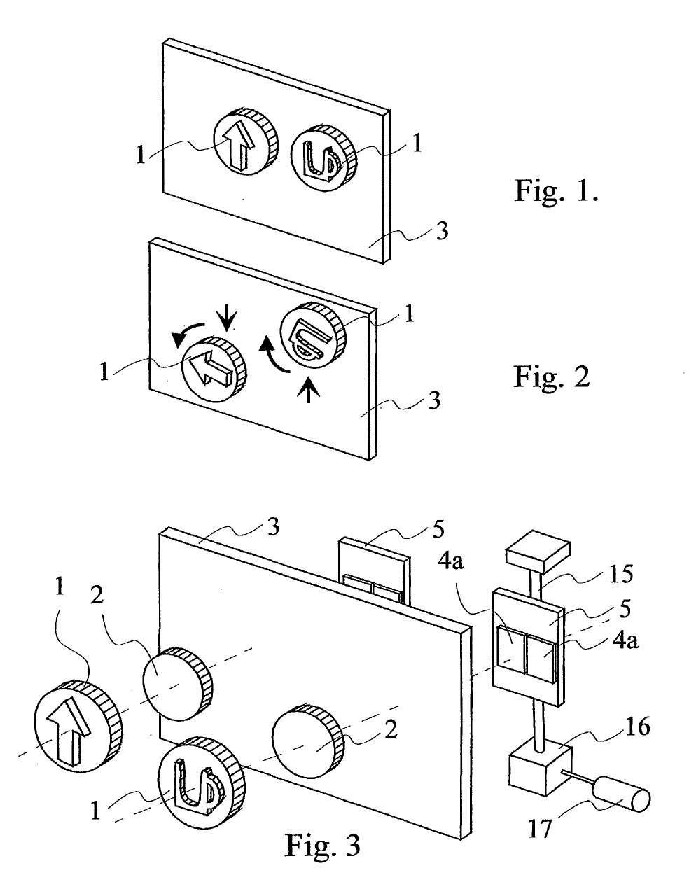

FIGS. 1 and 2 show a possible implementation of the magnetic translation and rotation device according to the invention. The space divider element 3 supports an element 1, which may perform various forms of motion, as explained below. Comparing FIGS. 1 and 2 it is seen that the elements 1 moved upwards and downwards, respectively, while they also turned in a plane parallel to the plane of the space divider element 3. There is no further structural element on the space divider element 3, and therefore the movement of the element 1 appears puzzling for the observer.

FIGS. 3, 4 and 5 show the structure of one embodiment of the inventive magnetic translation and rotation device. A magnetic cylinder 2 is disposed on one side of the space divider element 3 that is bounded by two substantially plain surfaces. The magnetization of the magnetic cylinder 2, symbolized by arrows drawn inside said magnetic cylinder 2 and pointing, according to definition, e.g. from the south to the north pole, is parallel with the longitudinal axis of the magnetic cylinder 2, which is perpendicular to the plane of the space divider element 3. Magnetic plates 4a, 4b are attached to the transport means 5, situated opposite the magnetic cylinder 2 along the other side of the space divider element 3, so that the polarities of the magnetic plates 4a, 4b are opposite to each other. The directions of magnetization of the magnetic plates 4a, 4b are again indicated by small arrows. Thus, the north pole of the magnetic plate 4b points toward the space divider element 3, while the north pole of the other magnetic plate 4a points into the opposite direction. The transport means 5 enables the movement of magnetic plates 4a, 4b with respect to the space divider element 3 and fixes the magnetic plates 4a, 4b together in the desired opposite-polarity position.

The transport means 5 can be implemented in a number of ways. With the embodiment shown in FIG. 3, the motion of the transport means 5 is provided by a simple mechanism, namely with the motor 17 driving the transport means 5 through a drive screw 15 and a gear transmission 16. As it will be shown, it is desirable that the driving mechanism should provide for a motion of the transport means 5 at least in a direction substantially perpendicular to the line that connects the centres of the magnetic plates 4a, 4b, because such an arrangement enables the magnetic cylinder 2 to rotate while moving along a straight line.

The effect described above is illustrated in FIG. 5. In case the magnetic cylinder 2 is placed above the magnetic plates 4a, 4b, it is balanced substantially in a position shown in FIGS. 1-2. The balance position is determined by the attraction of magnetic plate 4a and the repulsion of magnetic plate 4b. If the transport means 5 is displaced in any direction, due to magnetic interaction the magnetic cylinder 2 tends to preserve its position with respect to the magnetic plates 4a, 4b, so the magnetic cylinder 2 strives to displace in the same direction as the magnetic plates 4a, 4b. The relative displacement of the space divider element 3 and the magnetic cylinder 2 results in a frictional force arising between these two objects, with a point of application of the frictional force substantially at the centre of the area of their contact. (It is understood that the area of contact is assumed to be the area of the overlapping surfaces of magnetic plate 4a and magnetic cylinder 2, because the forces pressing the magnetic plate 4a and magnetic cylinder 2 together are caused by the mutual attraction of the two magnets.) Frictional forces F4′ and F4″ operate at this point.

As, in accordance with what has been stated above, the magnetic cylinder 2 can in principle rotate about its axis T without the application of substantial external forces, and the magnetic cylinder 2 behaves in the field of magnetic plates 4a, 4b as if it was revolving about a real physical axle, and the axis T of the magnetic cylinder 2 can be regarded as the resultant point of application of magnetic forces F5′ and F5″ arising between the magnetic cylinder 2 and the magnetic plates 4a, 4b. Consequently, for describing the behaviour of the magnetic cylinder 2 it can be assumed that the attractive or repulsive magnetic forces arising upon the displacement of the magnetic plates 4a, 4b in directions D3 or D1 exert the resultant magnetic forces F5′ or F5″ applied at axis T.

If the magnetic plates 4a, 4b are displaced along direction D1, that is, along the direction of the line that connects the point of application of the frictional force F4′ arising between the space divider element 3 and the magnetic cylinder 2 and the resultant point of application of magnetic forces F5′ arising between the magnetic cylinder 2 and the magnetic plates 4a, 4b, then a straight-line motion corresponding to the direction D1 is transferred from the magnetic plates 4a, 4b to the magnetic cylinder 2. In this case, two forces act on the magnetic cylinder: the magnetic force F5′ and the frictional force F4′, which (as soon as the motion has stabilised) have substantially equal magnitudes and act in opposite directions. So the magnetic cylinder 2 will perform straight-line motion with even speed, substantially following the motion of the transport means 5 in direction D1.

If, on the other hand, the magnetic plates 4a, 4b are displaced along a direction other than D1, that is, along a direction different from that of the line connecting the point of application of the frictional forces arising between the space divider element 3 and the magnetic cylinder 3 and the resultant point of application of magnetic forces acting between the magnetic cylinder 2 and the magnetic plates 4a, 4b, then, depending on the direction of displacement, a rotation into different directions can be produced, which is superimposed on the translational displacement of the magnetic cylinder 2, resulting in a combination of rotation and straight-line movement. The relative amount of straight-line motion and rotation can be controlled by adjusting the angle between the direction of the displacement of the magnetic plates 4a, 4b and the direction of the line that connects the point of application of the frictional forces arising between the space divider element 3 and the magnetic cylinder 2 and the resultant point of application of magnetic forces arising between the magnetic cylinder 2 and the magnetic plates 4a, 4b.

The rotation of the magnetic cylinder 2 is produced as follows: For angular velocities within consideration, induced eddy currents can be neglected, and at first the effect of weight forces may be disregarded as well. Magnetic plate 4a exerts an attractive force, whereas magnetic plate 4b exerts a repulsive force on the magnetic cylinder 2. So, as it can be seen in FIG. 2, in the resulting magnetic field the magnetic cylinder 2 is pulled towards the space divider element 3 in a position which is apart from the centre point of the magnetic plate 4a. At the same time, as long as we fix axis T in the reference frame of magnetic plates 4a, 4b, the axial symmetry of the magnetic cylinder 2 ensures that the magnetic cylinder 2 can be rotated about its centre, that is, about axis T. Thus, if the point of application of the axis T of the magnetic cylinder 2 were to be displaced with respect to the magnetic plates 4a, 4b, that could only be done against the magnetic forces. It can now be stated that if we move the magnetic plates 4a, 4b, attached to each other and to the transport means 5, then, although they will cause the magnetic cylinder 2, situated on the other side of the space divider element 3 to perform translation, magnetic forces in themselves will have no effect on the rotation of the magnetic cylinder 2 about the axis T thereof. The magnetic translational force in question neither causes nor retards such a rotation. At the same time, in the whole course of the movement the resultant frictional force acts in a direction substantially parallel with but opposite to the direction of the magnetic translational force. If the frictional force has an arm, it can cause the magnetic cylinder 2 to rotate.

For instance, as it can be seen in FIG. 2, if magnetic plates 4a, 4b are displaced along a direction D3 that is perpendicular to, or at least has a component perpendicular to the direction of the line that connects the point of application of the frictional force F4″ arising between the space divider element 3 and the magnetic cylinder 2—as an effect of the magnetic attractive and repulsive forces and the resultant point of application of the magnetic forces F5″—, then a torque M2 producing clockwise rotation is applied to the magnetic cylinder 2. As it is shown in FIG. 2, in that case the lines of action of magnetic force F5″ caused by movement in direction D3 and frictional force F4″ do no longer coincide, and therefore an arm of non-zero length is produced between them. Because the magnetic force F5″ and the frictional force F4″ act in opposite directions (and have equal magnitudes under the condition of even (stationary) movement), a torque M2 is produced. This torque M2 will cause the magnetic cylinder 2 to rotate about axis T (while, of course, the axis T will also move in direction D3 as it is fixed to the moving magnetic plates 4a, 4b). In other words, the resultant motion will be a combination of rotation and straight-line displacement. The relative amount of translation and rotation is affected by the geometry of magnets 2, 4a, 4b, their magnetic characteristics, the relative position of magnetic plates 4a, 4b and the magnetic forces F5′, F5″ depending on it, and also by the frictional forces F4′, F4″ arising between the space divider element 3 and the magnetic cylinder 2; and finally the movement direction D3 of the magnetic plates 4a, 4b relative to the direction D1 that determines the proportion of translation to rotation. If, for instance in one extremity, when the magnetic plates 4a, 4b move in direction D1, the component of the movement parallel with D3 is zero, and consequently no torque is applied to the magnetic cylinder 2. That can be appreciated by considering that the direction of the line that connects the point of application of the frictional force F4′ and the resultant point of application of magnetic forces F5′ coincides with the direction of the displacement, so the arm between forces F4′ and F5′ will vanish.

It is also appreciated that if the magnetic plates are moved in the reverse direction, all forces and directions mentioned above turn to their opposites, which causes the magnetic cylinder 2 to move and/or rotate also in the opposite direction. If we mount the magnetic plates 4a, 4b in an inverted position, it can be appreciated that the system will show the mirror image of the behaviour seen above, which means, for example, that the movement of the magnetic plates 4a, 4b in direction D3 will cause the anti-clockwise rotation of the magnetic cylinder.

We can exploit the movement of the magnetic cylinder 2 by attaching an additional element 1 to it, the element 1 preferably constituting a surface with advertising information. The information is illustrated by the arrow and the glass-like motif on FIGS. 1 and 2.

If the transport means 5 moves along a vertical plane, we have to take into account the weight of the magnetic cylinder 2 and element 1 when designing the inventive device. In that case, for instance when we apply the inventive device in a vertical advertising board design, it is preferable to use a lightweight element 1.

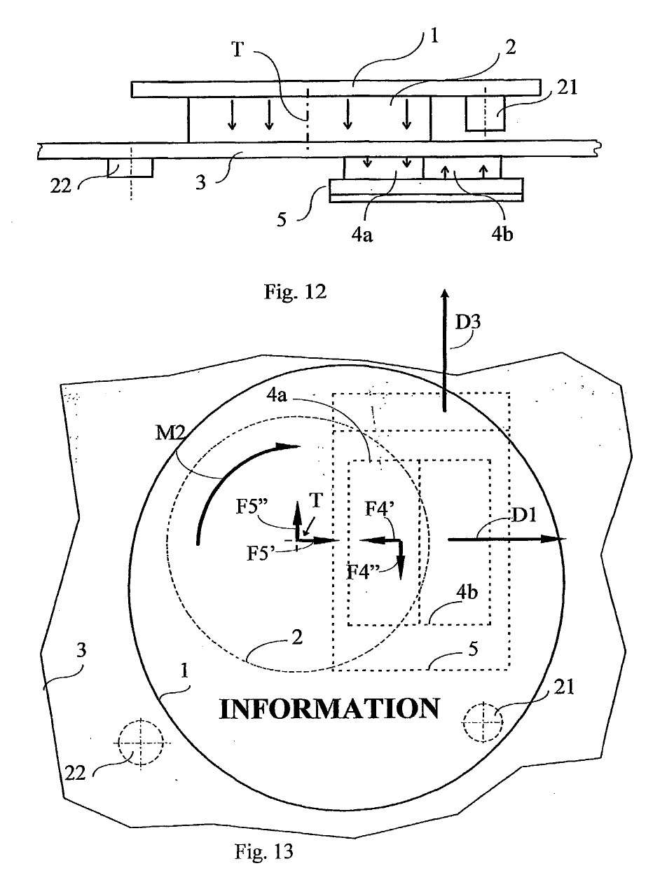

Referring to FIGS. 12 and 13, another advantageous embodiment is shown. The magnetic cylinder 2 transports an element 1, to which a guiding means 21 (e.g. a magnet) is fixed. A guiding counterpart 22 (made e.g. of iron) is mounted on the space divider element 3. When situated in each other's range of attraction, the guiding means 21 and guiding counterpart 22 guide the element 1 with respect to the space divider element 3.

The guiding process can be illustrated with the following example. Imagine a vertical advertising board, in which the device according the present invention is applied. On the vertical space divider element 3 of the advertising board five moving elements 1 are disposed in a horizontal row. All five elements 1 are of the same size and are identical to the element 1 as depicted in FIG. 2. As advertising information, each moving element 1 may bear a single letter: from left to right the letters are “A” “P” “P” “L” “E”, thereby together forming the word “APPLE”. Now the transport means 5, disposed behind the space divider element 3, is displaced into direction D3, carrying five pairs of magnetic plates 4a, 4b. The magnetic plates 4a, 4b move the five elements 1 bearing the letters “A” “P” “P” “L” “E” vertically upwards so the elements 1 move upwards, rotating clockwise at the same time. By the time the centers of rotation of the elements 1 cover the distance of the diameter of the magnetic cylinder 2 traveling upwards along the surface of the space divider element 3, the elements 1 will have completed several revolutions. In the course of their movement, the elements 1 are further and further removed from the guiding means 22 (made e.g. of iron) which is mounted 6n the space divider element 3. After some time the transport means 5 stops, then it begins to move again, this time in a direction opposite to D3. The downward motion of the transport means 5 causes the elements 1 to begin to descend as well, at the same time rotating anti-clockwise. This uniform downward translation and rotation of the letters continues until any of the guiding means 21 (magnets) fixed to the elements 1 enters into the range of attraction of the guiding counterpart 22, which latter is mounted on the space divider element 3. As soon as that happens with any of the elements 1, the guiding means 21 (magnet) which enters into the pulling range of the guiding counterpart 22, is stuck to the space divider element 3 opposite the guiding counterpart 22, and stops the rotation of the element 1. The letter is painted on the element 1 in such a way that in this position said letter is oriented in a substantially vertical direction. After the element has been oriented in this manner, the centre of the element 1 may eventually continue the downwards movement for a short time (e.g. for one second), but the element 1 there will no longer rotate, but may tilt slightly. During that short period of time all the other elements 1 will be oriented, because the guiding means 21 (magnets) will approach to their counterparts 22, and thereby the guiding means 21 will stick to the space divider element 3. At this point, as if by magic, the word “APPLE” has all of its letters oriented in a vertical direction. The magnetic attractive forces between the guiding means 21 and the guiding counterparts 22 are chosen so as to be substantially smaller than the force that moves the element 1, that is, the force arising between the magnetic cylinder 2 and magnetic plates 4a, 4b. Thereby the translating force has a sufficient pull on the guiding means 21 to be able to release it from the attraction of the guiding counterpart 22 and enable the elements 1 to begin clockwise rotation once again, when the elements 1 are moved away again.

The magnetic plates 4a, 4b are preferably disposed between the space divider element 3 and the transport means 5.

The magnetic translation and rotation device according to the present invention transforms straight-line motion into rotation solely by means of magnetic and frictional forces, without the need for any further technical measures. Thereby it provides a reliable and inexpensive solution for engineering tasks where the aim is not only to transfer translation from one side of a space divider element to the other side thereof, but also to transform it into rotation. Such an application can be an advertising means having a vertical board with multiple objects moving and rotating along it. Due to the lack of any visible mechanical connection and the apparent lack of a transport means situated inside the space divider element the moving objects are especially conspicuous and can be of exceptional value in advertising. The arrangement according to the present invention has a further advantage: the magnetic plates 4a, 4b can be made extremely thin, which means that very little space is needed behind the space divider element 3, and consequently the space divider element 3 can be implemented as a wall advertisement board.

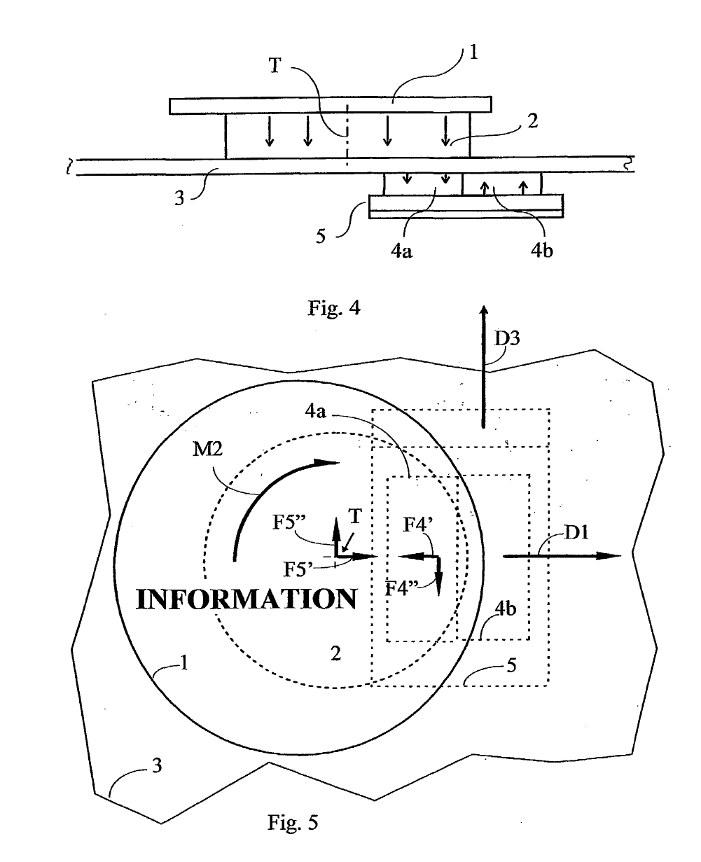

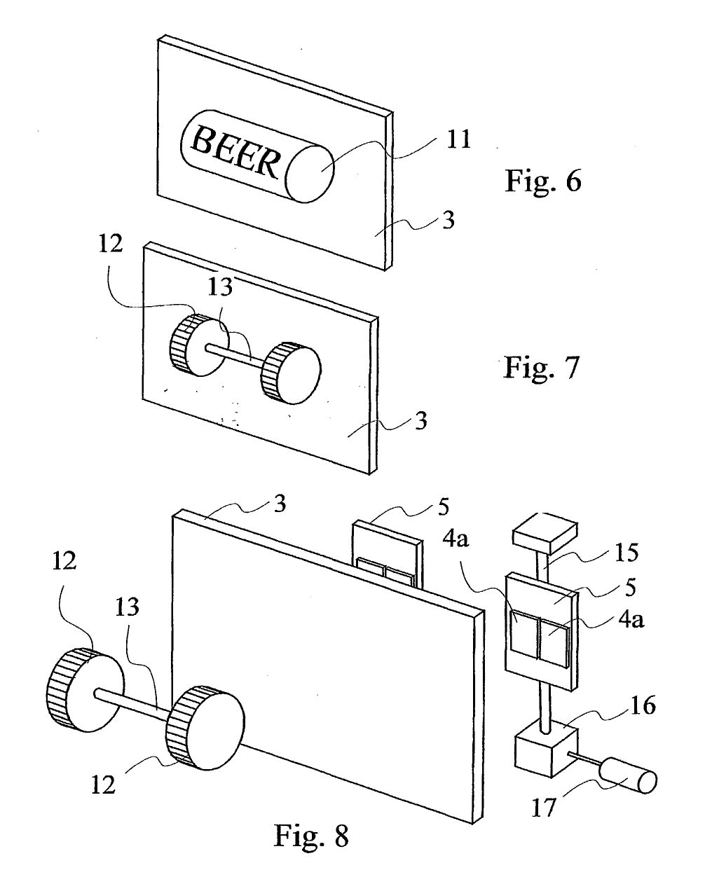

FIGS. 6 to 11 show another embodiment of the inventive magnetic translation and rotation device. The device depicted in the figures, similarly to the embodiments discussed above, transfers translational force and torque from one side of a space divider element 3 to the other side thereof. Similarly to the embodiments shown in FIGS. 1 to 3, a magnetic cylinder 12 with its direction of magnetization parallel with the longitudinal axis thereof is disposed on one of the plain surfaces of the space divider element 3. In this embodiment, however, the longitudinal axis of the magnetic cylinder 12 is parallel with the plane of the space divider element 3. Opposite the magnetic cylinder 12 on the other side of the space divider element 3 there are magnetic plates 4a, 4b mounted on a transport means 5, where the direction of magnetization of magnetic plates 4a, 4b is perpendicular with the principal plane of the magnetic plates 4a, 4b and the magnetic plates 4a, 4b are positioned in such a configuration that their polarities are opposite to each other, similarly to the arrangement shown in FIGS. 1 to 5. It is therefore appreciated that the transport means 5 comprising the pair of magnetic plates 4a, 4b is able to move reliably advertising means along the surface of the space divider element 3, which advertising means are designed different from what has been discussed above. As it is best seen in FIGS. 6 and 8, an advertising means 11, preferably also with a cylindrical shape, encloses the magnetic cylinder 12, thereby suggesting the image of e.g. a beer or soft drink can. As it can be seen in FIGS. 3 and 4, it is advantageous for this embodiment if the magnetic translation and rotation device comprises two pairs of magnetic plates 4a, 4b magnetized in directions perpendicular to their respective principal planes. These may be complemented on the other side of the space divider element 3 by two magnetic cylinders 12 arranged along a common axis 13, where the axis 13 is parallel with the plane of the space divider element 3. This configuration basically stabilizes the magnetic cylinders 12 with respect to the magnetic plates 4a, 4b and prevents the axis of the magnetic cylinders 12 from wobbling around the stable position.

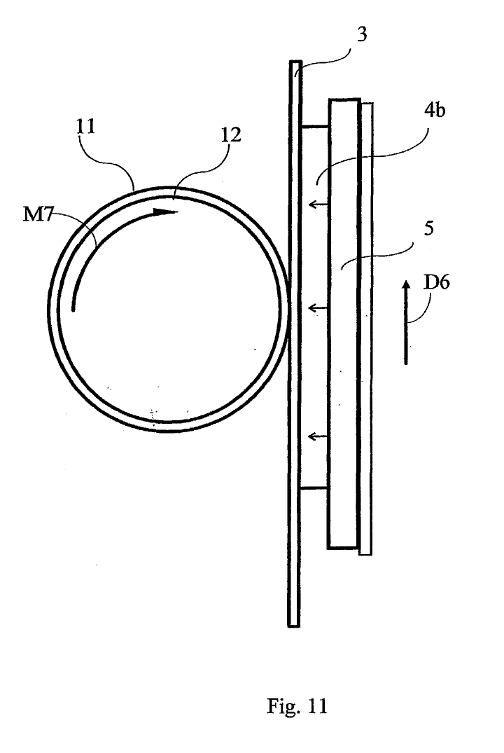

FIG. 11 illustrates the upward rolling motion of the advertising means 11 (or any other object) along the surface of the space divider element 3 in a rotation direction M7. The rotation is caused by the upward displacement of the transport means 5 (and of the magnetic plates 4a, 4b mounted on it) in direction D6.

The structure of the driving mechanism for the movement of the transport means 5 is the same as shown in FIG. 8. It is appreciated that in this manner the advertising carriers may be moved according to two types of movement transfer principles, while the space divider element 3 itself, more precisely, the structure of the transport means 5 and its associated driving mechanism need not be altered.

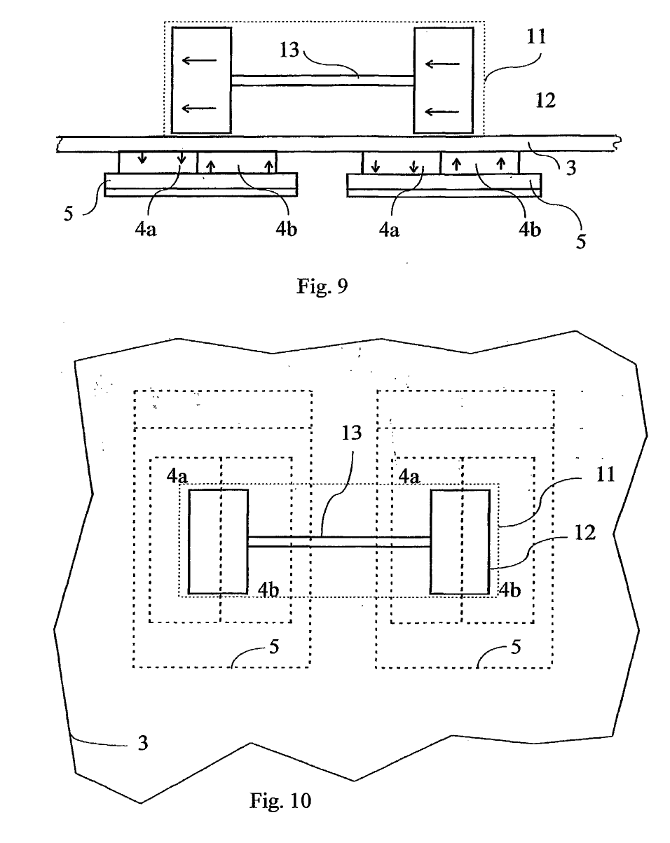

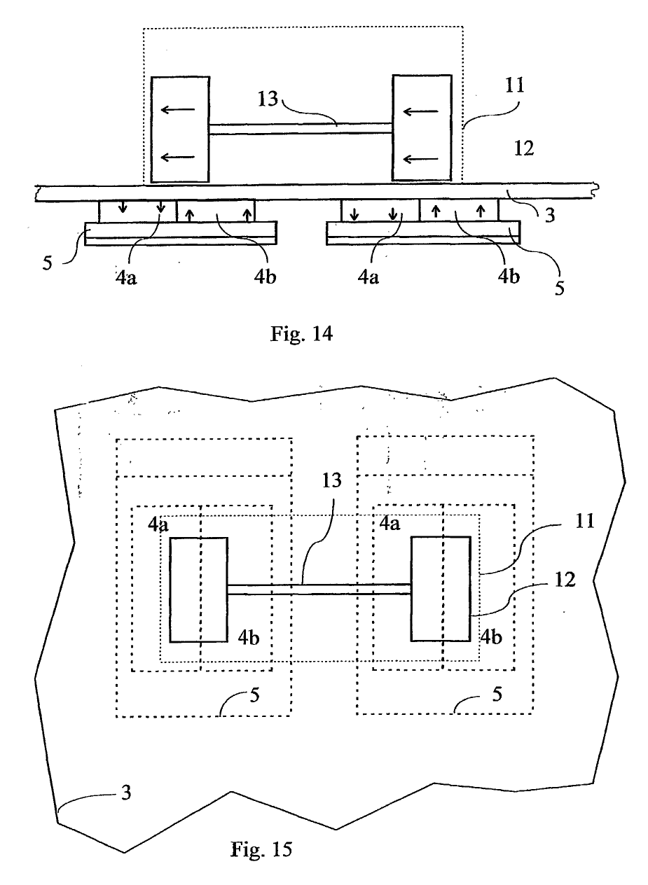

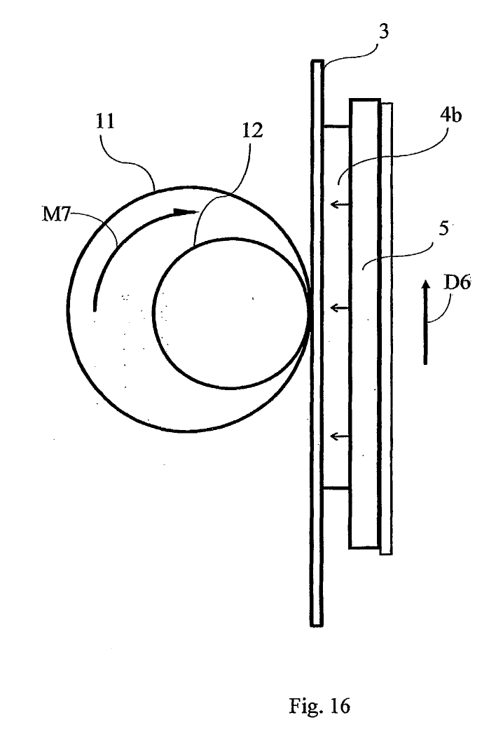

The embodiment shown in FIGS. 14-16 differs from the embodiment depicted in FIGS. 9-11 only in that the inner diameter of the advertising means 11 is substantially greater than the outer diameter of the magnetic cylinders 12. Therefore, as the magnetic cylinder 12 rolls over the surface of the space divider element 3 inside the advertising means 11, it causes the advertising means 11 to perform a rolling movement. In that case it is understood that the speed of rotation of the magnetic cylinder 12 is greater than the speed of rotation of the advertising means 11 by an amount determined by the ratio of the inner diameter of the advertising means 11 to the outer diameter of the magnetic cylinder 12, at least if the wall thickness of the advertising means 11 is negligible. If the wall thickness of the advertising means 11 can be safely neglected, then the speed of the advertising means 11 (and consequently the speed of rotation thereof) is practically independent of the outer diameter of the magnetic cylinder 12, and is determined solely by the speed of the magnetic plates 4a, 4b.

The present invention is not limited to the shown embodiments, but encompasses all combinations and variations of the disclosed features, and the scope of the inventions is only determined by the attached claims.

What is claimed is:

1. A magnetic translation and rotation device for transferring translational force and torque from one side of a space divider element to the other side thereof, comprising a magnetic cylinder disposed on a planar surface of the space divider element, with the direction of magnetisation of the magnetic cylinder being parallel with the longitudinal axis thereof, and the longitudinal axis of the magnetic cylinder being perpendicular or parallel to the plane of the space divider element; on the other side of the space divider element a pair of magnetic plates are disposed on a transport means, where the direction of magnetisation of the magnetic plates is perpendicular to the principal plane of the magnetic plates, wherein the magnetic plates are mounted with their direction of magnetisation pointing in opposite directions.

2. The device according to claim 1, wherein the longitudinal axis of the magnetic cylinder is perpendicular to the plane of the space divider element, and the magnetic cylinder transports an element attached to it.

3. The device according to claim 2, further comprising multiple magnetic parts mounted on the element transported by the magnetic cylinder, which magnetic parts guide the element with respect to the space divider element.

4. The device according to claim 2, further comprising guiding means attached to the element transported by the magnetic cylinder, and a guiding counterpart attached to the space divider element, said guiding means and counterpart guiding the element with respect to the space divider element, when situated in each other's range of attraction.

5. The device according to claim 1, wherein the longitudinal axis of the magnetic cylinder is parallel to the planar surface of the space divider element, comprising two pairs of magnetic plates, wherein the direction of magnetisation of the magnetic plates is perpendicular to the principal plane of said magnetic plates, with said magnetic plates complemented on the other side of the space divider element by two magnetic cylinders arranged along a common axis that is parallel with the plane of the space divider element.

6. The device according to claim 1, wherein the magnetic plates are situated between the transport means and the space divider element.

7. A method for transferring straight-line motion and rotation from one side of a space divider element to the other side thereof by means of magnets, comprising positioning a magnetic cylinder on one side of said space divider element, where the direction of magnetisation is parallel with the longitudinal axis of the magnetic cylinder, and the longitudinal axis of the magnetic cylinder being perpendicular to the plane of the space divider element, further positioning magnetic plates opposite the magnetic cylinder on the other side of the space divider element, the magnetic plates being attached to transport means, where the magnetic plates are magnetised in a direction perpendicular to their planes, and positioning the magnetic plates in a configuration so that their polarities are opposite to each other, and further moving the magnetic plates along the space divider element in a direction different from the direction of a line connecting the points of application of the frictional force arising between the space divider element and the magnetic cylinder and the resultant point of application of magnetic forces arising between the magnetic cylinder and the magnetic plates, so that a rotary movement of the magnetic cylinder results which is superimposed on the translation of the magnetic cylinder, so that the magnetic cylinder will undergo straight-line motion and rotation at the same time.

8. The method according to claim 7, further comprising attaching an element to the magnetic cylinder and translating the element with the magnetic cylinder.

9. The method according to claim 8, further comprising mounting a guiding means on the element carried by the magnetic cylinder, and further mounting a guiding counterpart is on the space divider element, so that the element is magnetically guided with respect to the space divider element in the range of attraction of said guide and guiding counterpart.

10. The method according to claim 8, further comprising mounting multiple magnetic parts are on the element carried by the magnetic cylinder, by means of which the element is guided with respect to the space divider element.

11. The method according to claim 7, further comprising mounting a guiding means on the element carried by the magnetic cylinder, and further mounting a guiding counterpart is on the space divider element, so that the element is magnetically guided with respect to the space divider element in the range of attraction of said guide and guiding counterpart.

12. The method according to claim 7, further comprising mounting multiple magnetic parts are on the element carried by the magnetic cylinder, by means of which the element is guided with respect to the space divider element.

13. The method according to claim 7, further comprising positioning the magnetic plates between the space divider element and the transport means.

14. The method according to claim 7, further comprising determining the relative amount of straight-line motion to rotation during the movement of the magnetic cylinder by the direction of the movement of the magnetic plates with respect to the direction of a line, the line connecting the point of application of the frictional force arising between the space divider element and the magnetic plate and the resultant point of application of magnetic forces arising between the magnetic cylinder and the magnetic plates.

15. A magnetic translation and rotation device for transferring translational force and/or torque to the other side a space divider element by means of moving magnets attached to a transport means disposed along a planar surface of the space divider element, comprising a pair of magnetic plates disposed on a transport means, where the direction of magnetisation of the magnetic plates is perpendicular to the principal plane of the magnetic plates, wherein the magnetic plates are mounted with their direction of magnetisation pointing in opposite directions.

16. The device according to claim 15, wherein the magnetic plates of substantially equal size, and that the transport means is implemented in such a way that it allows for a motion at least in the direction perpendicular to the line connecting the magnetic centres of the magnetic plates.
